(19) United States
(12) Patent Application Publication
(10) Pub. No.: US 2014/0278538 A1
(43) Pub. Date: Sep. 18, 2014

(54) Method to format and use matrix bar codes and other identification code conventions and tools to enroll end users of products and services into a data supply chain

(71) Applicants: Stanley Benjamin Smith, Fort Mill, SC (US); Reed Altman, Raleigh, NC (US); Joseph Sherman Tate, Raleigh, NC (US)

(72) Inventors: Stanley Benjamin Smith, Fort Mill, SC (US); Reed Altman, Raleigh, NC (US); Joseph Sherman Tate, Raleigh, NC (US)

(21) Appl. No.: 13/845,015

(22) Filed: Mar. 17, 2013

(51) Int. Cl. G06Q 10/06; G06Q 50/22

(52) U.S. Cl. CPC G06Q 10/0635; G06Q 50/22
USPC 705/3

(57) ABSTRACT

A system to use strings of computer readable characters, such as QR codes, biometric data captured from electronic devices, and RFID tags to instruct a server or electronic device to register a user upon receipt of the strings of computer readable characters.

### BACKGROUND OF THE INVENTION

1. Field of the Invention

The system and method of this divisional application for the invention assigned U.S. Pat. No. 8,271,346 relates to the enrollment of participants into a data supply chain through configuration and transmission of matrix codes, such as Qrcodes, SPARQcodes, Microsoft Tags and other bar codes readable by electronic devices capable of running computer readable code. More specifically, it introduces art to format and configure matrix codes and other codes or strings of characters to enroll contributors into a data collection and processing method and system to use for research or risk management or feedback to manufacturers or service providers upon sale or distribution or exchange of a product or service; also including transaction fees, payment, and other methods for rewarding contributors of data. Also included in the code formatted to implement the enrollment process is registration for receipt of notifications, alerts and updates for participants in a data supply chain. Use of a matrix code associated with an enrollee is also included.

2. Description of the Related Art

Adverse side effects of medications and product defects in manufactured biological and chemical agents or medical or protective devices and equipment can result in harm or loss. Indeed, many products or services may pose a risk to users, purchasers or recipients. Product recalls of automobiles, food, toys, and medicines that were thought to be safe occur with regularity. Gaps in time between trends in data indicating risk and analysis and action regarding that risk can result in unnecessary loss of lives and property. Implementing a rapid enrollment method to facilitate end user input into datasets to be used for data analysis or to trigger notifications and feedback to manufacturers, providers, users, regulators, and other vested parties will enable early warning of emergent problems and rapid response to emergent problems associated with a product or service. Notifications, alerts, and other communications distributed to participants in a data supply chain and to regulatory agencies, manufacturers, service providers, and individual end users of products and services will enable better management of risks and liabilities. Use of this divisional application for the invention assigned U.S. Pat. No. 8,271,346 will enable manufacturers and service providers to be informed in real time of product or service risks and liabilities. The same system and method may also uncover hitherto unanticipated advantages or benefits of a product or service.

The Department of Homeland Security and the FDA are encouraging development of systems and methods for real time tracking of the distribution, utilization, and positive or adverse impacts of biological and chemical agents or equipment that may be distributed through emergency response channels or through standard retail and other distribution channels and outlets. Enrolling users of products and services into feedback processes, especially feedback processes for pharmaceutical or medical devices, will support regulatory requirements to track risks and other data or information following regulatory approval. Indeed, studies of the long term effects and unanticipated interactions of medications or services, such as medical procedures, can offer significant social and economic benefit.

This divisional application for the invention assigned U.S. Pat. No. 8,271,346 has a preferred embodiment that includes formatting a Qrcode or any of the many variants of matrix code or other identification codes to enroll end users or customers into a data supply chain upon transfer or implementation or purchase or initiation of use of a product or service or procedure. The recipient as well as the vendor and provider enroll as data contributors or to serve other roles within a data supply chain. The term “data supply chain” is intended to describe a linked system of data contributors, protocols and formats for collection of data, data from automated entry and posting processes, data from persons that vet audit and analyze data, triggers and other processes and calculations that mark achievement of positive or negative thresholds of values within the dataset, server or electronic device and human actions resulting from trigger thresholds being reached or surpassed, communications notifications or additional server or electronic device actions back to contributors and other participants, and forward or backward chains of server or electronic device actions that may be initiated by achievement of trigger conditions.

An additional use of matrix codes in this divisional application for the invention assigned U.S. Pat. No. 8,271,346 is the optional assignment of a matrix code carrying identity and other data to a potential enrollee into a data supply chain, enabling enrollment to be completely automated through the use of matrix codes.

This divisional application for the invention assigned U.S. Pat. No. 8,271,346 can be included into any of the processes for offering reviews and feedback through social networks and through direct registration into feedback formats and processes on websites managed by manufacturers or producers as well as by software as a service (SaaS) vendors. Structuring automated enrollment and payment or incentives for real time end user input into a disciplined research process included within a well designed data supply chain will advance the public interest.

Art to implement data supply chains and provide incentives to participate in data supply has been evolving. This divisional application for the invention assigned U.S. Pat. No. 8,271,346 advances the advantages of the data supply chain with triggered real time notifications introduced by Smith (U.S. Pat. No. 7,860,760). That system and method, Smith (U.S. Pat. No. 7,860,760), enables pricing of notifications and server actions triggered by new or updated data streamed or posted into a dataset. Smith (Ser. No. 12/932,798) also teaches art to weight and price contributions from variably weighted sources and variably weighted observations of research targets or data items. This invention is a Continuation in Part of that patent application by Smith (Ser. No. 12/932,798). Additional art introduced by Smith (Ser. No. 12/932,797) describes a system and method for calculating fees for interaction of a user with a graphical user interface (GUI) on a website or host server housing a dataset or a plurality of datasets accessible through the GUI. This divisional application for the invention assigned U.S. Pat. No. 8,271,346 positions the enrolled participants to interact with GUI's as described by Smith (Ser. No. 12/932,797) if the data collector or enrolled data contributor opt to engage in the pricing and fee exchanges of that system and method. Further art introduced by Smith (Ser. No. 13/134,596) offers a system and method to facilitate and price data exchange from electronic devices linked to the systems and methods of Smith (U.S. Pat. No. 7,860,760, Ser. Nos. 12/932,797, 12/932,798). Art has also been described, Smith (DatasetIteration) to integrate fees and rewards for contributions to data accumulation processes within Social Networks or networks of users and servers or websites. Smith (Ser. No. 13/136,421) also introduces a system and method for pricing linking of message streams and RFID tags and UPC codes to data sources.

While each of the systems and methods cited here can be implemented completely independently of one another, an integration of the systems and methods cited herein will facilitate the social objective of encouraging the evolution of real time data supply chains to reduce risks and leverage knowledge and information. The art described in the invention herein will support that effort by providing a method and system for rapid enrollment of participants into a data supply chain and can operate independently or be folded together with other systems and methods involving a data supply chain. At every point within a data supply chain, recruitment of data contributors and transaction fees and prices can be implemented and established.

Clinical Research Organizations and other research service providers enroll contributors of data and feedback into research processes and programs that include access to formal protocols. For example, Clinical Research Organizations enlist interviewers or agents to collect data from physicians who observe risks or side effects, or provide survey forms and materials to physicians or other health care providers to complete regarding observations of side effects and drug interactions and medical outcomes. Often, responses to questions on the survey forms are manually entered into datasets by data entry technicians or entered through survey form reading software, introducing a potential for data entry errors. Additionally, when Clinical Research Organizations conduct telephone surveys and use other forms of personal contact such as office visits and interviews to actively collect data from users of pharmaceuticals or other products, the agents collecting the information may misinterpret or inaccurately record the information. The system and method of the invention for rapid enrollment of contributors described herein reduces the common lag time between end users of products and services registering and posting observations of side effects or responses to a pharmaceutical or medication and increases the potential for accurate structured data entry. Broadly distributed enrollment of contributors to a data supply chain can supplement, enhance, and serve to check or verify the quality of data obtained through personal interaction and interviews, especially if control or comparison groups are part of the follow on study processes for long term side effects.

Another common method for collecting data is to email a link to the website housing a survey to a potential contributor. Manufacturers and service providers often retain SaaS vendors that offer email linking and other survey research capabilities. Companies and services such as SurveyMonkey or Zoomerang enable researchers to construct and deliver surveys and link contributors into the survey administration processes. Research and survey organizations like Gallup and Gartner also structure temporary or permanent links between their sites and distributed groups of contributors to collect input into survey research forms. Data collected through these survey research organizations is analyzed at intervals, sometimes even regular intervals. However, the delay between input and analysis and notification of persons or entities that might be subject to risks or liabilities can be costly in terms of lives and other consequences. The system and method described herein integrates communication and notification methods upon enrollment to reduce lag time between discovery of risk and alerting the right person with the right information in real time or at the right time.

An industry has evolved to enable the processing and interpretation of data gathered through survey collection tools. Art introduced by Smith (U.S. Pat. No. 7,860,760) enables the bypassing of much of the data processing required in survey research and moves directly to triggered actions based upon thresholds or triggers set by researchers or physicians or others engaged in risk management as data is accumulated in real time. Post hoc analysis of the collected data is still available, but the delay between input related to known risks or risk thresholds and initiation of alerts is eliminated. Art introduced by Smith (Ser. No. 12/932,798) of which this patent is a Continuation in Part enables the weighting of input sources and the weighting of targets for observation and can be integrated with the art of Smith (U.S. Pat. No. 7,860,760) to improve relevance, timeliness and utility of data collected. If contributors of data enter responses and observation into protocols that are sufficiently specific and are enabled to offer sufficient detail or context regarding the side effect or event, the quality and utility and appropriateness of the response and analysis may be enriched.

Eliminating the complexities of enrollment of contributors and bypassing the multiple steps and processes required for analysis prior to action enables risk management to be more efficiently and effectively managed on a larger scale and can leverage the art in Smith (U.S. Pat. No. 7,860,760) without sacrificing the quality of the data collected. However, without social and monetary incentives to encourage enrollment, or without monetization of the enrollment transaction as introduced by the system and method of this divisional application for the invention assigned U.S. Pat. No. 8,271,346, the volume of real time collection of observations from widely dispersed sets of enrollees in real time is likely to be lower, resulting in slower accumulation of data that might trip a risk and notification trigger or threshold. The combination of a simple enrollment process with rewards and incentives and monetization of the process for enrollment will facilitate a robust and continuous supply of actionable real time data.

The emergence and wide distribution of smart phones and other electronic devices capable of implementing computer readable code expands the technological capacity to include end users of products and services into rigorous research processes efficiently and automatically. In the event of national regional or local emergencies, tracking the distribution and utilization and impact of distributed resources or assets along with receiving continuous feedback from emergency responders or citizens in possession of these resources or assets may help to save lives and improve decision making regarding levels of risk, prioritizing allocation of resources, and other factors. Enrolling both emergency responders and citizens rapidly and efficiently into real time contributions of data to datasets of value to governmental or regulatory agencies and other stakeholders or entities for the regulation, management, or reduction of risks to public health or welfare is essential for managing emergency and crisis situations. Linking the user of the resource, the provider of the resource, ad hoc or pre-validated research protocols, and real time triggering of alerts and notifications can enable a truly flexible real time responses to emergency situations.

Users and producers of data in the various forms of databases, data tables, streams of data from RFID tags, data generated by and through messaging services and social networking sites, and data generated by the multitude of electronic devices capable of implementing computer readable code will benefit from improved and additional tools for enrolling voluntary contributors of data into a data supply chain. This divisional application for the invention assigned U.S. Pat. No. 8,271,346 addresses a system and method for achievement of a subset of a data supply chain we have labeled C1 in the group of four fundamental components of a data supply chain we label as “Delta4C:”
1. C1=Connect and enroll participants rapidly and effectively from a distributed network or community of observers into a process for data contribution
2. C2=Collect real time observations from a full circle of contributors with variable weighting for reputation and access to relevant information
3. C3=Compute the values and ratings of accumulated observations to assess whether thresholds for risks or alerts have been met or surpassed
4. C4=Communicate or notify the right parties regarding information that is actionable for them

The method and system of this divisional application for the invention assigned U.S. Pat. No. 8,271,346 focuses upon the term labeled “C1” in the list and enables rapid enrollment of end users of products or goods and services as contributors of real time actionable intelligence and information to be used to reduce risks in times of national emergency and to provide routine incremental observations. The method and system will also enable implementation of transaction fees and charges to be paid to the provider or vendor doing the enrollment and also enable the producer of the product or service to implement rewards, fees, bounties, coupons, and other incentives for contributions of data to a data supply chain. Using the system and method, FDA, CDC, HSA, FEMA, DOD and other agencies or entities may accumulate input from dispersed contributors; including observations of the utility, effects, impacts, outcomes, side effects, associated risks, advantages, and quality or other measures and ratings useful for assessing a manufactured item or service or process. Indeed, the system and method can be applied to any subject or topic for research, such as biological or social or environmental interactions. The system and method of the enrollment process also carries sufficient information to inform citizens and emergency responders of actions to undertake through real time communication and notifications.

The FDA has begun to consider tools and mechanisms for a “flexible, nimble system to produce medical countermeasures rapidly in the face of any attack or threat, known or unknown,” and the rapid enrollment of contributors to the data supply chain of observations regarding risks and liabilities along with the notification processes will facilitate risk assessment and allocation of resources during emergencies. The data supply chain and accompanying infrastructure will enable the goal of the FDA's MCMi regulatory science program (Pillar II): “to facilitate, simplify, and speed the development and evaluation of medical countermeasures by . . . risk communication to improve public health outcomes, . . . and real-time tracking and evaluation of MCM safety and efficacy during public health emergencies.” There are significant benefits to meliorating risks through capturing real time observations from a full circle of observers regarding drugs and medical devices and other manufactured products and services by proactively notifying providers, patients, and manufacturers as risks are identified. Easing processes to enable every responsible party and every user of a medication or medical device or product or service to contribute weighted, vetted, context rich data regarding side effects, drug interactions, contamination, manufacturing defects, or other potential concerns before they endanger consumers or escalate into liabilities will make consumers safer and provide emergency responders with actionable intelligence as they formulate policy and determine courses of action. The richer the information regarding the contributor of data, such as the contributor's medical history or genetic map or demographic information, the more comprehensive the analysis and interpretation of the interaction of the contributor and the product or service. Generating and assigning matrix codes to potential enrollees into a data supply chain can leverage information the enrollee chooses to make available to the research process as well as facilitates the automation of registration, assignment and transfer of payments and fees and other incentives, and assignment of the enrollee to the proper subset of systems and processes and research protocols within a data supply chain.

### BRIEF SUMMARY OF THE INVENTION

Users and producers of data in the various forms of databases, data tables, streams of data from RFID tags, data generated by and through messaging services and social networking sites, and data generated by the multitude of electronic devices capable of implementing computer readable code will benefit from improved and additional tools for enrolling voluntary contributors of data into a data supply chain. This divisional application for the invention assigned U.S. Pat. No. 8,271,346 introduces art to configure, format, and utilize matrix codes, such as Qrcodes, SPARQcodes, Microsoft Tags, and other computer readable matrix or bar codes that may be read and transmitted to a server or electronic device or website by smart phone readers or other electronic devices with camera capabilities. This divisional application for the invention assigned U.S. Pat. No. 8,271,346 will use computer readable code to configure, format, and generate a matrix code or a code string to print directly upon any product label or on a receipt for a product or service or printed on a page or poster or card associated with a product or service, including UPC codes to be read at the point of sale or distribution of a service or product. This divisional application for the invention assigned U.S. Pat. No. 8,271,346 will also use computer readable code to configure, format, and generate a matrix code or a code string to assign to a potential contributor or participant in a data supply chain The act of a smart phone or other electronic device photographing and transmitting the code to enable enrollment automatically connects the user to a web page according to instructions embedded within the matrix code regarding:
1. The fee to collect from an organization or business or agency for enrolling the consumer or user of the product or service into a data supply chain wherein said enrollment enables the consumer or user to input information into specific research or data collection protocols or forms regarding research questions related to the service or product and for receipt of notifications or alerts if risk or other thresholds or triggers get tripped by calculations performed upon the accumulated data.
2. The price or award or other form of recognition or exchange to be offered or paid to a person contributing data to said research protocols.
3. The rights and roles assigned to the user of the product or service to enter observations regarding the product or service
4. The rights and roles assigned to the user of the product or service to configure processes for notification and alerts if cumulative calculations upon the data exceed thresholds set by the manufacturer, the service provider, the agency or organization, or the user respectively.
   The optional act of a smart phone or other electronic device photographing and transmitting the matrix code assigned to the person to be to enrolled automatically posts the designated data, and connects the enrollee into the data supply chain.

### BRIEF DESCRIPTION OF THE DRAWINGS

FIG. 1 “Diagram of Matrix Code Instruction, Component and Content Adjustment” diagrams how a server implements matrix codes to enroll users into assigned datasets, and manages those datasets and integrates them with testing and processing and user rights to post to forms and update and transmit notifications and reports.

FIG. 2 “Diagram of System Components” diagrams how matrix codes assigned to the enrollee and the product or service are linked to electronic devices with camera and transmission capabilities and servers housing and processing datasets.

FIG. 3 “Diagram of System Roles, Actors, Entities” diagrams how users, servers, and other entities connect to the dataset and how assigned roles and rights to design, manage, and contribute observations, process payments and other rewards are arranged in a typical embodiment of this divisional application for the invention assigned U.S. Pat. No. 8,271,346.

### DETAILED DESCRIPTION OF THE INVENTION

Several problems consistently disrupt or prevent continuous collection and real time distribution of actionable data about risk:
Data collection and utilization is inconsistent
Enrollment of contributors is complex
Data is dispersed
Data is delayed
Collection is intermittent (everyone reports on their own schedules) and incoherent (continuity across protocols and tracking of biomarkers is essential for real time research)
Data is insufficient (the patients know most about the impact of the drug on them, but do not usually have the tools or training to know how to contribute that information in real time or in a structured manner)
Intervening variables associated with the patient, such as their genetic map or medical history or demographics, can significantly qualify the interpretation of the collected data
Data input does not conform to regulatory standards or requirements
Absence of tools for triggering actions based on data available to risk managers
   A partial solution to this dilemma is available through the system and method of the invention herein to rapidly enroll participants into real time research processes, especially if the participant is enabled to offer some or all medical history, genetic maps, and demographic information upon enrollment through porting of a matrix code or other structured and ordered data associated with the participant. Enabled through the enrollment process are capabilities to:
Post/offer and discover data to a central location from patients, providers, regulators, and pharmaceutical companies or manufacturers or service providers;
Push and pull data from the full circle of contributors in real time;
Collect and federate data through rigorous protocols that comply with regulatory standards and requirements;
Collect and curate rated, vetted, scored, and structured data along with searchable context-rich narratives;
Enable real time data accumulation from observers of risks and links to governmental regulatory agencies and other stakeholders;
Provide a self-service interface for simple data sharing that conforms to regulatory requirements and standards;
Use triggering to process and notify the right party about actionable data and potential risks—even patients and providers.
Automate notification of the right party as regulatory or risk profile thresholds get tripped by triggers established by stakeholders;
Leverage social networks for collecting observations and posting alerts;
Generate, upon distribution or receipt of a service or product or chemical, a matrix code to enable a handshake or link between the registrant or data contributor and the rest of the supply chain;
Utilize the cameras in smart phones and other mobile devices to capture the matrix codes that enable direct links to servers and devices housing research protocols and enroll participants into the data gathering process;
Enable the observation interface to be initiated upon first use of the service or product or when a purchaser voluntarily opts in to participate in risk management at the point a product or service agreement is received or made or exchanged;
Enable regulators or experts to vet and validate data as it is input into the system to ensure relevance, utility, accuracy, data quality, priority or urgency and maintain data consistency;
Post and link vetted observations to regulatory or research or quality control datasets external to the primary dataset(s);
Notify and/or perform other automated actions based on set schedules or upon changes to data;
Collect transaction fees and distribute rewards, bounties, prizes, social recognitions and incentives, and payment for contributions of observations;
Update demographic, connection, medical, genetic, or other data associated with the enrolled participant.

A non-intrusive “everybody wins” enrollment approach enables even an ordinary purchase transaction to be capable of invoking a connection to a risk management or a product improvement system. In effect, the system and the chain of enrollment and contribution can be invoked and initiated for any product or service that is of interest to national security or national health at the point of discovery as well as any product or service in the private sector that might benefit from continuous real time research or protocol oriented data collection and posting for triggered alerts and/or notifications. In fact, using the system and method of this divisional application for the invention assigned U.S. Pat. No. 8,271,346 with other art introduced to implement and manage a data supply chain enables any set of people to shape the unfocused disordered data that crosses their transom into ordered and structured processes for notification and alerts.

The system and method of this invention facilitates monetization for activities related to enrollment of contributors to datasets. This divisional application for the invention assigned U.S. Pat. No. 8,271,346 introduces art to configure, format, and utilize matrix codes, such as Qrcodes, SPARQcodes, Microsoft Tags, and other computer readable matrix or bar codes that may be read and transmitted to a server or electronic device or website by smart phone image readers or other electronic devices with camera capabilities in order to enroll and link a user to a data supply chain. Further, in some embodiments of this divisional application for the invention assigned U.S. Pat. No. 8,271,346, a combination of one or a plurality of RFID data tags readable by an electronic device or a GUID code for users of Microsoft operating systems to connect with COM DLL's may be included in the connection methods used to link to servers or electronic devices included in a data supply chain. Many additional conventions for electronic tags and operating system codes may emerge, and the invention anticipates folding these into the connection systems and methods that will enable an enrollment process. A connection to at least one server or electronic device participating in a data supply chain is a precursor to enabling the implementation of fees and charges for enrolling contributors and for implementing the transmission of bounties, coupons, awards, rewards and other social or economic incentives to motivate contributors to offer observations in real time with sufficient accuracy and context. To the extent that these supplemental linking processes through codes such as GUID's or RFID tags are also able to carry instructions for fees for enrollment and payment and incentives to contributors, the system and method described herein may be adjusted to accommodate these, especially if they improve the universality or efficiency of the enrollment process. Further, to the extent that these supplemental linking processes through codes in addition to matrix codes, such as GUID's or RFID tags are also able to carry medical histories, genetic maps, demographic, financial transaction information, and other data regarding the enrollee; fees allocated to the enrollee may be adjusted according to the rarity or value of their individual data and its utility and value to the research process associated with the data supply chain as well as facilitate the automation of enrollment.

Terms used in the description of this divisional application for the invention assigned U.S. Pat. No. 8,271,346, such as “contributor” “enrollee” “participant” “researcher” “person” and other terms for “user” are interchangeable. The use of a different term is for purposes of remaining within the context of an embodiment or anticipated embodiment, and is not intended to change the definition commonly applied to the term “user” by the USPTO.

An embodiment of the invention can also enable enrollment of a contributor some time following the purchase of a product or service if the recipient of the product or service can be identified or contacted and invited to enroll into the data supply chain through email solicitations or other electronic forms or methods or through mailers or personal contact. This embodiment may optionally include a matrix code with already known medical and other information associated with the potential enrollee, as well as a matrix code for the product or service that is the object of the data collection process for the data supply chain. Another embodiment of the invention can enable any entity engaged in real time research or risk management, such as a federal or state agency, or city, or county, or business to enroll a person into a data supply chain process at the point of purchase or check-out or payment or registration for a service or business transaction with that entity. In these cases, links to credit card information or tax information or other electronic datasets containing information about the enrollee may be accessed with the permission of the prospective enrollee and data relevant to the enrollee's participation in the data supply chain can be linked to the server or electronic device or website implementing the enrollment. The matrix code may include instructions to accept a series of passwords and identifying information to enable a user upon first accessing the server housing the research protocols for the data supply chain to configure their rewards and build links to banks or other entities involved in financial transactions or services resulting from their participation.

In one embodiment, the UPC code is embedded into the matrix code and the act of reading the matrix code by an electronic code reader would be similar to a point of sale transaction. In another embodiment, information about a chain of service providers and organizations or agencies would be embedded into the matrix code for posting into data collection processes and systems at a website specified within the matrix code. Yet another embodiment of this divisional application for the invention assigned U.S. Pat. No. 8,271,346 can be applied to enrollment or registration of employees into an organization, enabling a full circle of citizens, organizational actors, supervisors, peers, and individual employees to participate in a data supply chain for assessing performance in regard to jobs or work roles or goals. Similarly, citizens can be enrolled or register to provide observations of service needs or requirements or performance of entities and persons who provide services to them as citizens. The option to receive notification and the distribution paths and types and methods and contents of the notifications can vary according to the needs and choices of the enrollee or the policies of the organizations or entities enrolling the contributors. In every embodiment, where enrollment occurs using the system and method of this divisional application for the invention assigned U.S. Pat. No. 8,271,346, fees and other exchanges may be assigned and designated within the matrix code or code string used to register and enroll the contributor into the data supply chain. An example of how this operates in the pharmaceutical arena is that the physician may be assigned a fee from the manufacturer, the retailer may also be assigned a fee from the manufacturer, the regulatory agency overseeing the side effects of the medication may designate the posting of the name of the physician onto a site for “Preventative Medicine Contributors,” the enrolled contributor or user may be assigned a coupon or reward from the manufacturer, the service provider housing the dataset may be assigned a transaction processing fee by the manufacturer or by the regulatory agency or both, and a link to an entity processing financial transactions implemented.

The configuration and combination of compensation and incentives to enrollees into the data supply chain is embedded within the matrix code or code string. The act of reading the matrix code or code string takes the potential data contributing participant ton the data supply chain to the correct link to a dataset and carries with it the rights and roles and rules for enabling the contribution as well as the rules and processes for implementing transaction fees and payment methods and processes. If a matrix code is already assigned to the user, the user who is opting to contribute data simply transmits the code to the server registering enrollees. The user who is opting to contribute data, but does not have a matrix code assigned, simply enters an email address and/or other contact, routing, payment, and supplementary identification information into forms posted by the website or server or electronic device and may also opt to check a checkbox to receive notifications about the product or service; and be offered a form to enter a side effect or a reaction or evaluative response into the research protocol at that point or upon reconnection to the website or server or electronic device.

If the data contributing participant in a data supply chain does not have a smart phone with camera capability or requests an alternative to the matrix code, a website or server address and a string of characters may be provided to the potential data contributing participant at the point of exchange or purchase of the product or service. Upon accessing the website or server, the potential data contributing participant will be presented with a form to accept the string of characters and register the data contributing participant and provide said participant with access to the right data entry form or forms. In this embodiment, a gateway URL is printed on the item or product or distributed with the service along with the character string to enter when said participants connects to the URL.

What has been described above includes examples of the system and/or method for the patent described herein. It is not possible to describe every combination of processes or utilities or configurations for purposes of describing the system and/or method of the patent described herein, but one of ordinary skill in the art may recognize that many further combinations and permutations of the system and/or method are possible. Accordingly, the system and/or method of the patent described herein is intended to include alterations, modifications, and variations that fall within the spirit and scope of the appended claims.

Furthermore, to the extent that the term “includes” is used in the detailed description or claims, the term is intended to be a synonym of the term “comprising” as “comprising” is interpreted when employed as a transitional word in a claim.

1. A system for formatting a data string or matrix code to instruct a server or electronic device to register a user upon receipt of an image of the matrix code or upon receipt of the data string wherein said system comprises an electronic device capable of executing computer readable code to:
offer said user an option to draw from said data string or matrix code and post upon the server contact information, such as email addresses, phone numbers, and addresses from said data string or matrix code or a data table upon a server upon connection to that server;
offer said user an option to draw from said data string or matrix code and post upon the server demographic information, such as age, gender, health status, and occupational history from said data string or matrix code or a data table upon a server upon connection to that server;
offer said user an option to draw from said data string or matrix code and post upon the server information regarding a medical history from said data string or matrix code or a data table upon a server upon connection to that server;
offer said user an option to draw from said data string or matrix code and post upon the server information regarding a gene map from a data string or matrix code or a data table upon a server upon connection to that server;
offer said user an option to draw from said data string or matrix code and post upon the server social network links and information upon connection to that server;
offer said user an option to draw from said data string or matrix code and post upon the server further or additional data within the data string or matrix code upon connection to that server;
and offer said user an option to draw from said data string or matrix code and post upon the server banking and credit card and other financial transactional links from a data string or matrix code or a data table upon a server upon connection to that server.

2. A system for a server or electronic device to generate a revision to a data string or matrix code comprising an electronic device capable of executing computer readable code to:
associate said revised data string or matrix code with a data string or matrix code of an enrolled contributor included into the data supply chain;
connect to the electronic device or server originating the initial or prior version of the data string or matrix code;
offer said user an option to implement a link from the server to the electronically writable medium or device capable of generating a data string or matrix code;
offer said user an option to draw from said server one or a plurality of modifications to write to the electronically writable medium or device one or a plurality of changes to a data string or matrix code assigned to said user;
offer said user an option to manually or to automatically post or overwrite the current version of the data string or matrix code on the originating server;
and offer said user an option to the user of the server to collect a fee or payment for the one or a plurality of modifications of the original data string or matrix code.

3. The system as in claim 1 for enabling said user enrolling into a data supply using a data string or matrix code to:
accept one or a plurality of the fields or links posted onto the server from said data string or electronically readable identification or matrix code for acceptance or rejection to be stored on the server;
accept a solicitation for updates of one or a plurality of fields from said data string or matrix or electronically readable identification code marked for storage on the server;
and accept access on a server associated with the enrolled contributor or participant from said electronically readable identification or matrix code to download one or a plurality of fields marked for storage on the server.
